(19) United States
(12) Patent Application Publication
(10) Pub. No.: US 2009/0042065 A1
(43) Pub. Date: Feb. 12, 2009

(54) Event Activated Micro Control Devices

(75) Inventors: Steve Simon, Middletown, NJ (US); Victor A. Lifton, Bridgewater, NJ (US)

Correspondence Address: NEUSTEL LAW OFFICES, LTD., 2534 SOUTH UNIVERSITY DRIVE, SUITE 4, FARGO, ND, 58103, US

(73) Assignee: MPHASE TECHNOLOGIES, INC., Little Falls, NJ (US)

(21) Appl. No.: 11/837,429

(22) Filed: Aug. 10, 2007

(51) Int. Cl. H01M 14/00

(52) U.S. Cl. 429/8; 429/110; 429/111; 429/112; 429/116

(57) ABSTRACT

A method of activating a micro-cell in which the micro-cell includes a first compartment, a second compartment, a fluid in the first compartment, an element in the second compartment and a porous barrier separating the first compartment from the second compartment. The porous barrier, in a first state, is operable to prevent the fluid from entering the second compartment whereas the porous barrier, in a second state, is operable, in response to an event, to allow the fluid to enter the second compartment and interact with the element in the second compartment so as to generate an activation signal.

### BACKGROUND

This disclosure relates to event activated micro control devices. In general, event activated control devices generate a signal that can be measured and recorded, in response to a particular event or action. The signal generated by the control device may be used, for example, to activate a system or other device as a result of the event. In some implementations, the signal generated by the control device may be used as a means to detect the occurrence of a particular event or to detect tampering for security purposes.

In particular applications, event activated devices can be used to sense changes in the environment such as pressure, acceleration, gravitational, force, temperature, voltage, current, magnetic fields, electric fields, light and acoustic changes or, alternatively, to detect biological and chemical agents. Examples of systems that use event activated control devices include, for example, air bags, which are deployed in response to a change in acceleration; and chemical sensors, which emit warning alarms in response to detection of toxic chemicals.

### SUMMARY

The details of one or more embodiments of the invention are set forth in the description below, the accompanying drawings and in the claims.

For example, in one aspect, a micro-cell includes a first compartment that has a fluid, a second compartment that has an element, and a porous barrier separating the first compartment and the second compartment, in which the barrier, in a first state, is operable to prevent the fluid from entering the second compartment and in which the barrier, in a second state, is operable, in response to an event, to allow the fluid to enter the second compartment and interact with the element to generate an activation signal.

In another aspect, a method for activating a micro-cell includes causing an increase in pressure difference between a fluid in a first compartment of the cell and a vapor in a second compartment of the cell above a critical pressure, in which the increase in pressure difference allows the fluid to flow from the first compartment through a porous barrier into the second compartment.

In another aspect, a method for activating a micro-cell includes applying an external stimulus to the micro-cell to at least partially collapse a barrier in which the collapse of the barrier allows a fluid in a first compartment of the cell to pass into a second compartment of the cell.

In yet another aspect, a method of detecting an event or stimulus applied to a micro-cell includes detecting a signal representing the event or stimulus, in which the event or stimulus causes a fluid in a first compartment of the micro-cell to pass through a porous barrier and into a second compartment of the micro-cell and in which, upon entering the second compartment, the fluid interacts with an element in the second compartment to generate the signal.

In another aspect, a method of activating a device includes applying an event or stimulus to a micro-cell coupled to the device, in which the event or stimulus causes a fluid in a first compartment of the micro-cell to pass through a porous barrier and into a second compartment of the micro-cell such that an activation signal is generated when the fluid interacts with an element in the second compartment and in which the activation signal activates the device.

In another aspect, a method for activating a micro-cell includes applying a voltage across a fluid and a porous barrier, in which application of the voltage causes the fluid to flow from a first compartment, through micro-pores in the barrier, to a second compartment and in which an activation signal is generated when the fluid interacts with an element in the second compartment.

In some implementations, the micro-cell includes micro-pores that extend from the first compartment to the second compartment to allow passage of the fluid from the first compartment into the second compartment when the difference in pressure is greater than the critical pressure. The pores can have respective sidewalls, in which the critical pressure is a function of the fluid-vapor surface tension, the barrier pore size and a contact angle between the fluid and a pore sidewall. The interface between the fluid and vapor can be located at an opening of a pore in the barrier. Alternatively, the interface between the fluid and vapor can be located in a pore of the barrier.

In some implementations, the micro-cell includes a sub-structure supporting the barrier, wherein the sub-structure is arranged to break in response to the event such that the barrier at least partially collapses and allows the fluid to enter the second compartment.

In some implementations, the barrier includes a non-wetting surface. In some cases, the element is an electrode and the fluid is an electrolyte solution.

The activation signal can include an electrical signal, a magnetic signal, a visible signal, an auditory signal, or a thermal signal. The event can include acceleration or deceleration of the cell, a change in pressure applied to the cell, shaking of, vibrating or an impact applied to the cell, or application of an electric potential.

In some cases, the signal representing detection of the event or stimulus includes a color change in the fluid. In addition, the signal representing detection of the event or stimulus can include an electrical signal.

### BRIEF DESCRIPTION OF DRAWINGS

FIGS. 1A-1B are examples of an electrochemical cell.

FIG. 1C is a block diagram of an electrochemical cell coupled to a system.

FIG. 2 is an illustration of a liquid contact angle.

FIG. 3 is an illustration of a capillary.

FIG. 4 is an example of an electrochemical cell.

FIG. 5A is an example of a barrier.

FIG. 5B is a top view of a barrier.

FIG. 5C is a top view of a pore.

FIG. 5D is a side view of a pore.

FIGS. 6A-6B are examples of an electrochemical cell.

FIGS. 7A-7B are examples of an electrochemical cell.

FIG. 8 is an example of a package.

FIG. 9 is an example of a package.

### DETAILED DESCRIPTION

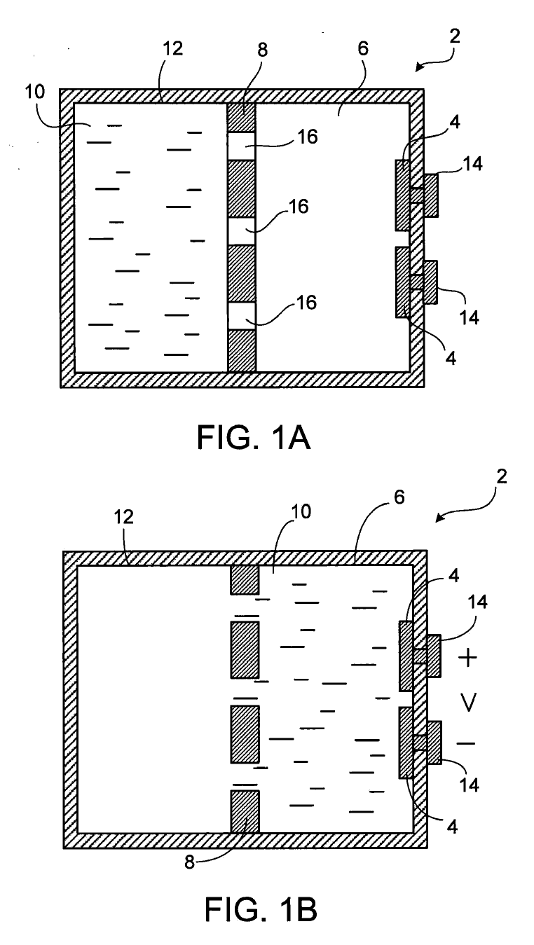

An example of an event activated micro control device in a first embodiment is presented in the context of an electrochemical cell 2 as illustrated in FIGS. 1A and 1B. The cell 2 is configured in a reserve state, in which electrodes 4 located in a first compartment 6 are isolated by a barrier 8 from a second compartment 12 containing a fluid 10 such as a liquid electrolyte. The term fluid, as used herein, refers to any liquid, vapor, gas or mixture thereof that is supportable on the barrier 8 and able to pass through openings in the barrier 8. The barrier 8 prevents the electrolyte solution 10 from contacting, and subsequently reacting with, the electrodes 4 in the first compartment 6. While the electrolyte is separated from the electrodes (see FIG. 1A), the cell 2 does not generate electricity. Upon activation of the cell 2, the electrolyte solution 10 passes through the barrier 8 and is introduced into the first compartment 6 (see FIG. 1B), such that the electrolyte 10 and electrodes 4 chemically react and produce a current or a potential difference V across the electrodes 4. The potential difference V can be detected using external terminals 14 which are connected to the electrodes 4. Alternatively, the cell 2 can be coupled to another device or system 11 such that the potential difference V generated across terminals 14 serves to activate the device or system (see FIG. 1C). Depending on the implementation, activation of the cell 2 can occur in response to external conditions or events such as excess vibrations, shock, pressure and/or acceleration, such as gravitational acceleration. Other external events or conditions also can induce activation of the cell 2.

The potential difference V produced across electrodes 4 is characteristic of the particular electrode and electrolyte combination used. Accordingly, the voltage generated may serve to provide confirmation of the activation event, in contrast to spurious signals in the environment. For example, a 1.5 volt difference can be generated across Zn/MnO₂ electrodes when the electrodes come into contact and electro-chemically react with a ZnCl₂ electrolyte solution. Other electrode and electrolyte combinations may be used as well to provide alternate potential differences or to supply electrical current. The potential difference or current is detected and measured on external terminals 14 which are connected electrically to the electrodes 4. In addition to detection, the potential difference or current generated by the electro-chemical reaction also can be used as a power source to activate other devices or systems. For example, in the context of automobiles, if the cell 2 is activated as a result of rapid deceleration, the potential generated across the electrodes can trigger deployment of an automobile air-bag.

In some embodiments, the electric potential or current produced by the interaction of the fluid and the electrodes can be used to generate activation or notification signals. For example, the electrodes may be coupled to an audio circuit that produces an audible alarm or signal indicating that a triggering event has occurred when the electric potential is produced. In another example, the electrodes may be coupled to one or more heater elements that serve to heat the device or provide an increase in ambient temperature upon generation of the electric potential. In another example, the electrodes may be coupled to a device that produces a magnetic field, such as a solenoid. In some applications, the electrodes may be coupled to a light emitting device such as a light emitting diode.

Alternatively, in some embodiments, the fluid 10 reacts with a corresponding chemical or biological agent upon entering the second compartment to produce a color change in the fluid 10 that is visible to a human. Such color changes may be used as a simple means of detection or threshold analysis. For example, the fluid 10 can be an acid-base indicator solution. In other embodiments, the fluid 10 chemically reacts with biological or chemical agents in the second compartment 12 to produce a color change in the fluid 10. The biological or chemical agents can be in solution form or, alternatively, they can be bound to the interior walls of the second compartment 12.

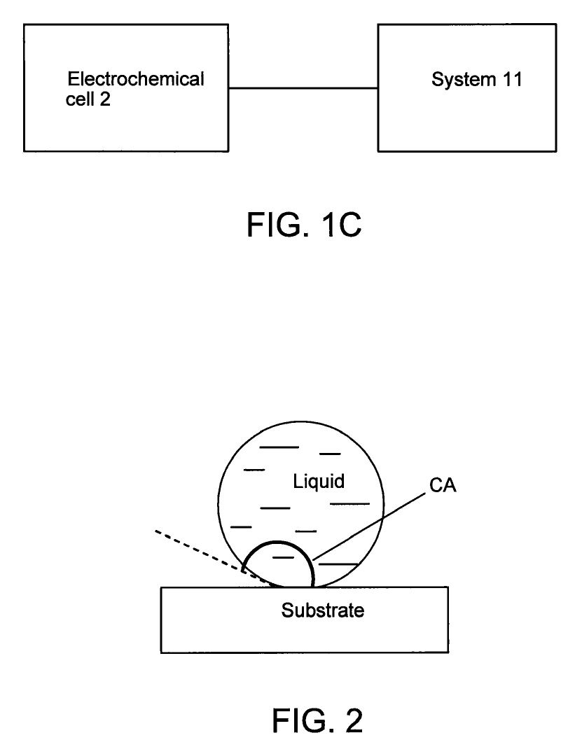

In the illustrated implementation, the barrier 8 is a porous micro-structure that includes a series of holes 16 extending from the first compartment 6 to the second compartment 12. The holes allow the electrolyte 10 to flow through the barrier 8 into the first compartment 6 under specific, pre-designed conditions. The surface of the barrier and/or the holes 16 can be formed such that they have super-lyophobic properties. As used herein, a lyophobic surface is a surface upon which a drop of liquid has a contact angle CA greater than 90°, the contact angle CA being measured between the solid-liquid interface and the liquid-vapor interface as shown in FIG. 2. Accordingly, the liquid drop appears to “bead up” on the lyophobic surface. A lyophobic surface discourages wetting of any fluid, including, for example, aqueous solutions or organic liquids such as hexane, methanol, and glycerol. Also, as used herein, a super-lyophobic surface is a surface upon which a liquid drop has a contact angle greater than 150°. A subset of lyophobic surfaces, which pertains to water and aqueous solutions, includes both hydrophobic and super-hydrophobic surfaces. A hydrophobic and super-hydrophobic surface refers to a surface upon which droplets of water have contact angles greater than 90° and 150°, respectively. In the absence of any external force or stimuli to drive the electrolyte through the pores 16, the super-lyophobic barrier surface substantially prevents the electrolyte 10 from flowing through pores 16 and into the first compartment 6.

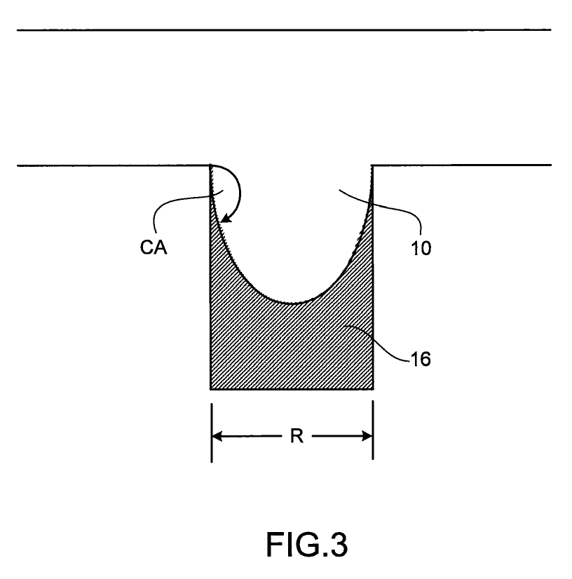

The stability of the electrolyte 10 on the porous super-lyophobic barrier 8 in this example is determined by the pressure stability of the portion of electrolyte 10 that enters each individual pore 16. For example, the electrolyte 10 and lyophobic pore 16 may be modeled as a capillary system as shown in FIG. 3. In this system, the pressure difference across the liquid-vapor interface at equilibrium is given by Δp_{c}=(2*γ)/R, where γ is the surface tension of the liquid at the liquid-vapor interface and R is the radius of the capillary. The critical pressure difference Δp_{c} is the minimum pressure needed to ensure that liquid flows through a pore 16 having a radius R to the opposite end of the barrier 8. When the pressure difference across the interface is equal to or less than Δp_{c}, however, the liquid cannot flow through the pore 16.

Accordingly, the pore size can be designed such that there is a critical pressure above which a liquid is forced through the pores. For example, if the cell 2 experiences an event which causes the critical pressure to be exceeded, the electrolyte 10 in the second compartment 12 flows through the pore 16 and exits on the opposite side of the barrier 8, where it reacts with the electrodes 4 in the first compartment 6 to generate a specified voltage across terminals 14. The voltage across terminals 14 then can be measured, detected or used to activate another device or system. Thus, any event which causes the critical pressure to be exceeded may be detected by measuring the voltage across terminals 14.

Events or stimuli which lead to the increase in pressure include, but are not limited to, vibration of or impact with the cell 2, a change in pressure in either the first compartment 6 or the second compartment 12, or an acceleration or deceleration of the cell 2. For example, the cell 2 can have flexible walls that move in response to an applied force such as vibrations or a change in atmospheric pressure. The movement of the cell walls then can lead to a pressure increase in the first compartment 6 or a pressure decrease in the second compartment 12 so that the critical pressure is exceeded and the electrolyte passes through the pores 16. In another example, the cell 2 can include an orifice on an outer wall through which pressure or vacuum can be applied externally. In another example, the cell 2 can undergo rapid acceleration such that the fluid 10 experiences high gravitational forces that increase the pressure difference above the critical pressure.

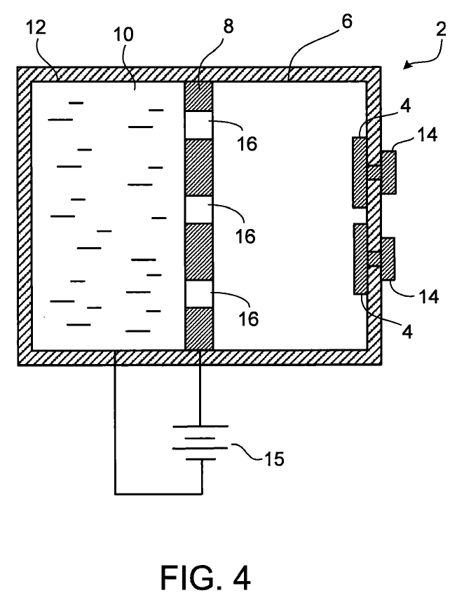

Alternatively, techniques known in the art as “electrowetting” or “electrowetting-on-dielectric” can be used to transfer the fluid through the pores 16. For example, an external voltage pulse 15 can be applied between the electrolyte 10 and the barrier surface to reduce the contact angle of the electrolyte 10 on the pore surface (see FIG. 4). Depending on the surface tension properties of the fluid 10, the properties of the pore 16, and the applied voltage, the liquid contact angle can be reduced enough such that the fluid 10 spreads easily through the pores 16 and into the second compartment 12. The fluid 10 then can react with the electrodes 4 in the second compartment. Accordingly, in some implementations, the cell 2 can be used to detect a change in voltage above or below a specified threshold voltage.

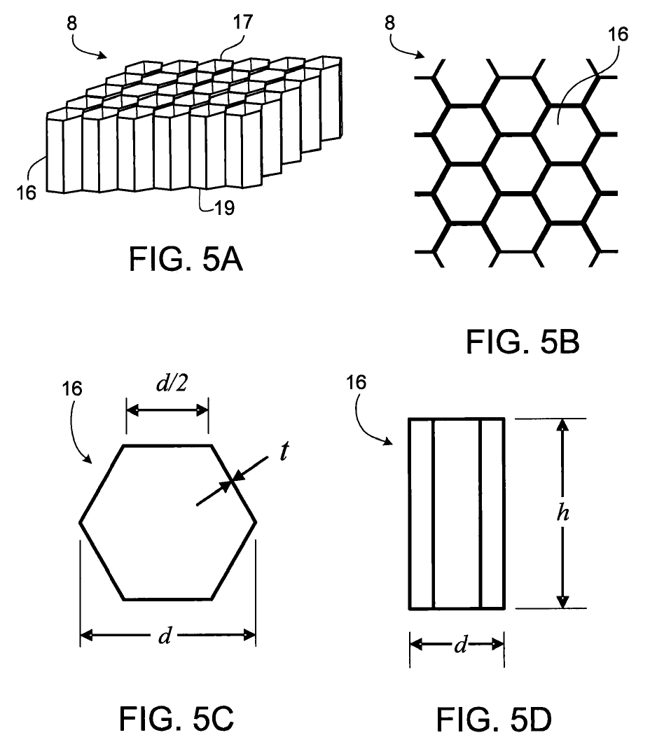

An example of a porous barrier 8 is illustrated in FIGS. 5A and 5B. The illustrated barrier 8 includes a series of hexagonally shaped pores 16 arranged in a lattice. As shown in FIG. 5A, each pore 16 extends from a first side 17 of the barrier 8 to a second side 19. As discussed above, the surfaces of the barrier 8 and the pores 16 can be coated with a super-lyophobic layer to help prevent fluid from entering the pores 16. The shape of each pore 16 is not limited to a hexagonal design. Other pore shapes can be formed in the barrier 8 as well. For instance, the pores 16 can be circular, square, or amorphous in shape. Preferably, the pore size is small enough that fluid cannot flow from the first side 17 to second side 19 without the application of an external force or stimulus. As an example, the pore opening can be formed to have a width d of approximately 10-40 microns, a height h of approximately 10-40 microns and a wall thickness t of approximately 1-2 microns as illustrated in the pore top view (see FIG. 5C) and side view (see FIG. 5D). However, other pore dimensions also can be used.

The super-lyophobic porous barrier 8 can be made, for example, of silicon using semiconductor and micro-electro-mechanical systems (MEMS) processing technologies. Alternatively, the barrier 8 can be formed of metal foils. For example, tantalum foil can be machined to create an array of through-holes using laser machining, chemical etching, or by stamping holes through the foil. The barrier 8 then can be oxidized using, for example, electrochemical oxidation or anodization, and coated with a lyophobic layer.

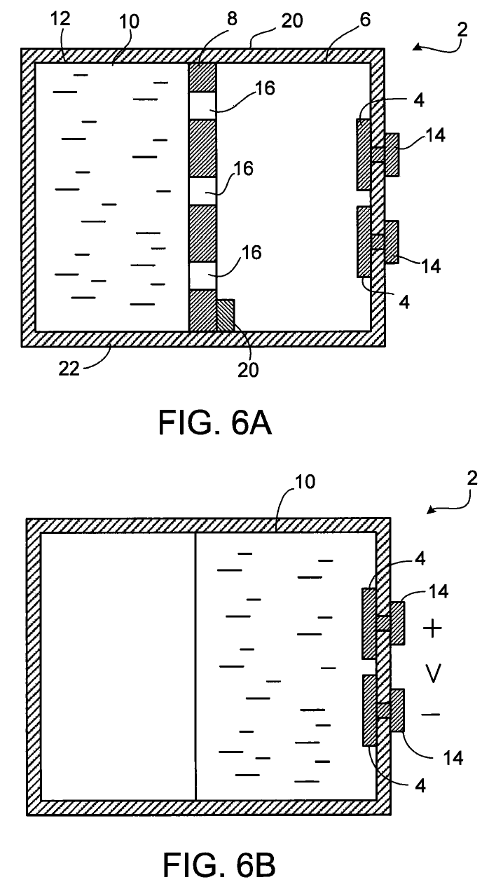

In some implementations, the super-lyophobic barrier 8 is supported by sub-structures 20 as shown in FIG. 6A. In the illustrated example, the sub-structures 20 are tabs or columns that serve to support the barrier 9 and may be broken off by a particular event or stimulus. For example, the sub-structures 20 can be designed to break off when a predetermined stress or frequency of vibration is applied to the cell 2. Once the sub-structures have broken, the barrier 8 collapses and releases the electrolyte 10 from the second compartment 12 into the first compartment 6 where the electrolyte 10 and electrodes 4 chemically react to produce a potential difference V across terminals 14 as shown in FIG. 6B. The sub-structures 20 can include, for example, portions of the cell walls 22 that protrude from the walls. Events which lead to the collapse of the sub-structures include, but are not limited to, acceleration or deceleration of the cell 2 and vibration of or impact with the cell 2.

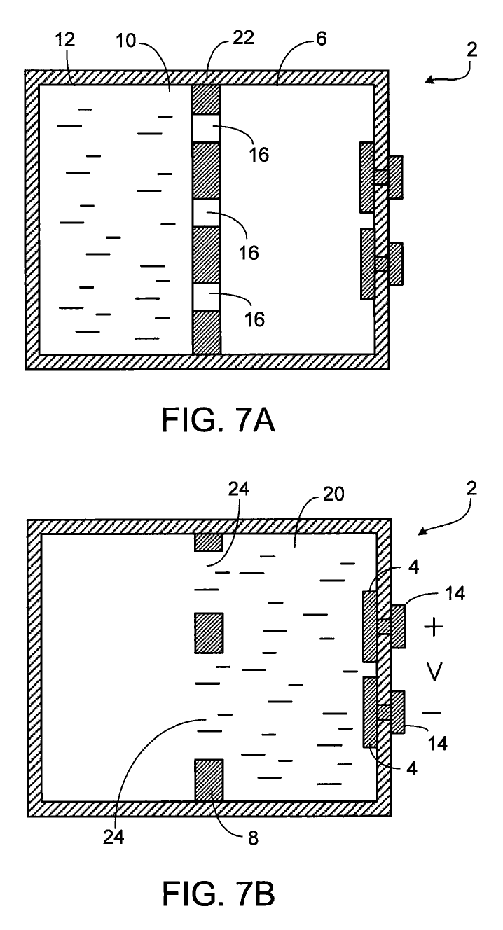

In some embodiments, the lyophobic porous barrier itself can collapse either partially or completely in response to a particular event or stimulus, without the use of sub-structures. As an example, FIGS. 7A and 7B show a porous barrier 8 fixed to walls 22 of the cell 2 before and after a specified event occurs. Prior to the event, the barrier is fixed in place and the electrolyte 10 cannot pass through the pores 16 (see FIG. 7A). After the event occurs, the barrier 8 partially or completely collapses exposing regions 24 large enough to allow the electrolyte to pass into the second compartment 12 and react with the electrodes 4 (see FIG. 7B). Alternatively, the barrier 8 can partially or completely dissolve in response to the event or stimulus.

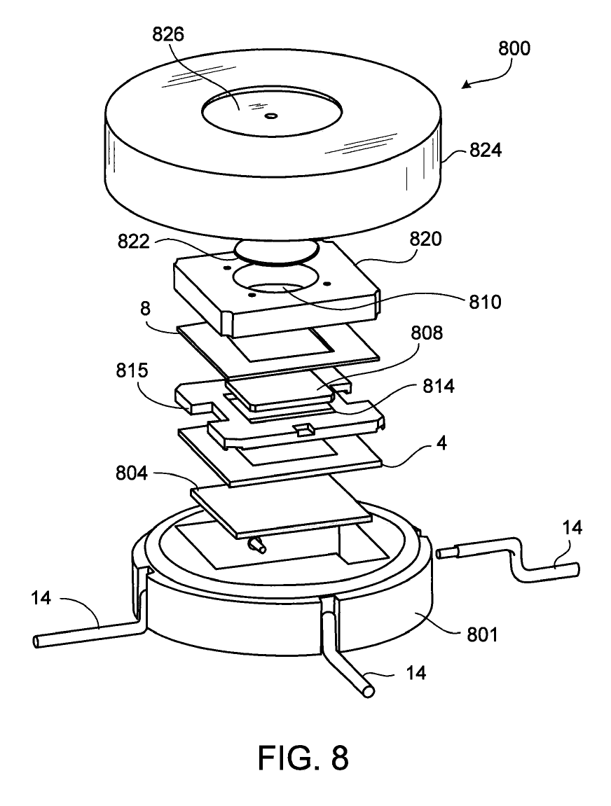

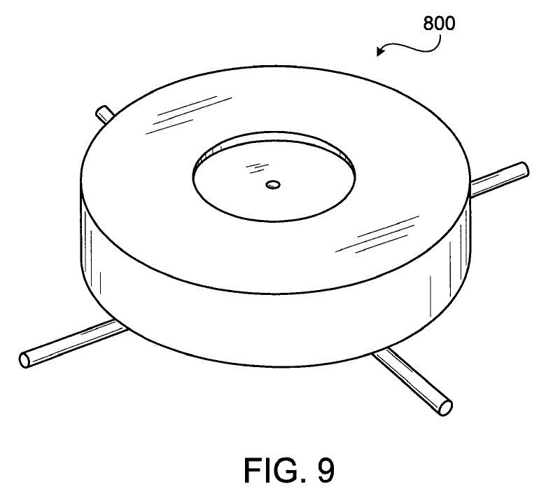

An exploded view of a package 800 that includes the electrochemical power cell 2 is shown in FIG. 8. The package 800 has a base 801 for holding external terminals 14. The external terminals 14 are electrically connected to electrode 4 inside the package base 801. The electrode 4 can be formed, for example, as a series of interdigited electrodes having alternating polarity. Other electrode designs may be used as well. A compliant sheet 804 can be provided beneath the electrode 4 to absorb shock and excessive force on the package 800. A spacer 815 between the electrode 4 and barrier 8 has an opening 814 in which a filter paper stack 808 can be placed. The filter paper stack 808 allows the electrolyte solution to spread evenly across the electrode 4. A reservoir 820 having an opening 810 is positioned above the barrier 8 and is used to hold the electrolyte solution. A second filter paper stack 822 can be placed in the opening 810 to facilitate even distribution of the electrolyte on the barrier 8. A metal cap 824 is secured to the package base 801 to confine the components and seal the electrolyte solution in the reservoir 820. In the illustrated example, the cap 824 includes a window 826 that allows a user to observe operation of the cell. For example, should the electrolyte solution change color upon reacting with the electrode 4, the color change can be viewed through the window 826. FIG. 9 illustrates an example of the package 800 fully assembled.

A number of embodiments of the invention have been described. Nevertheless, it will be understood that various modifications may be made without departing from the spirit and scope of the invention. Other implementations are within the scope of the claims.

What is claimed is:

1. A micro-cell comprising:
a first compartment;
a second compartment;
a fluid in the first compartment;
an element in the second compartment; and
a porous barrier separating the first compartment and the second compartment, wherein, in a first state, the porous barrier is operable to prevent the fluid from entering the second compartment and wherein, in a second state, the barrier is operable, in response to an event, to allow the fluid to enter the second compartment and interact with the element to generate an activation signal.

2. The micro-cell according to claim 1 wherein, in the first state, the porous barrier is operable to prevent the fluid from entering the second compartment when a difference in pressure across an interface between the fluid and a vapor is below a critical pressure and wherein, in the second state, the porous barrier is operable to allow the fluid to enter the second compartment when the difference in pressure is greater than the critical pressure.

3. The micro-cell according to claim 2 wherein the porous barrier comprises micro-pores extending from the first compartment to the second compartment to allow passage of the fluid from the first compartment into the second compartment when the difference in pressure is greater than the critical pressure.

4. The micro-cell according to claim 2 wherein the barrier comprises pores having respective sidewalls, and wherein the critical pressure is a function of the fluid-vapor surface tension, the barrier pore size and a contact angle between the fluid and a pore sidewall.

5. The micro-cell according to claim 2 wherein the interface between the fluid and vapor is located at an opening of a pore in the barrier.

6. The micro-cell according to claim 2 wherein the interface between the fluid and vapor is located in a pore of the barrier.

7. The micro-cell according to claim 1 wherein the barrier is arranged to break in response to the event such that the barrier at least partially collapses and allows the fluid to enter the second compartment.

8. The micro-cell of claim 7 further comprising a sub-structure supporting the barrier, wherein the sub-structure is arranged to break in response to the event such that the barrier collapses and allows the fluid to enter the second compartment.

9. The micro-cell of claim 7 wherein the barrier is arranged to partially collapse.

10. The micro-cell of claim 1 wherein, in the second state, the barrier is operable to allow the fluid to enter the second compartment upon application of a voltage across the fluid and the barrier.

11. The micro-cell of claim 10 wherein, in the second state, the barrier is operable to allow the fluid to pass through micro-pores in the barrier upon application of the voltage across the fluid and the barrier.

12. The micro-cell according to claim 1 wherein a surface of the barrier is non-wetting.

13. The micro-cell according to claim 1 wherein the element comprises an electrode.

14. The micro-cell according to claim 1 wherein the fluid comprises an electrolyte solution.

15. The micro-cell according to claim 1 wherein the activation signal comprises an electrical signal.

16. The micro-cell according to claim 1 wherein the activation signal comprises a magnetic signal.

17. The micro-cell according to claim 1 wherein the activation signal comprises a visible signal.

18. The micro-cell according to claim 1 wherein the activation signal comprises an auditory signal.

19. The micro-cell according to claim 1 wherein the activation signal comprises a thermal signal.

20. The micro-cell according to claim 1 wherein the event comprises acceleration or deceleration of the cell.

21. The micro-cell of claim 1 wherein the event comprises a change in pressure applied to the cell.

22. The micro-cell of claim 1 wherein the event comprises shaking of, vibration of or an impact to the cell.

23. The micro-cell of claim 1 wherein the event comprises application of an electric potential to the cell.

24. A method of activating a micro-cell comprising:
causing an increase in pressure difference between a fluid in a first compartment of the cell and a vapor in a second compartment of the cell above a critical pressure, wherein the increase in pressure difference allows the fluid to flow from the first compartment through a porous barrier into the second compartment.

25. The method according to claim 24 wherein the micro-cell generates an activation signal when the fluid interacts with an element in the second compartment.

26. The method according to claim 25 wherein the activation signal comprises an electrical signal.

27. The method according to claim 25 wherein the activation signal comprises a magnetic signal.

28. The method according to claim 25 wherein the activation signal comprises a visible signal.

29. The method according to claim 25 wherein the activation signal comprises an auditory signal.

30. The method according to claim 25 wherein the activation signal comprises a thermal signal.

31. The method according to claim 25 wherein the element comprises an electrode.

32. The method according to claim 24 wherein the fluid comprises an electrolyte solution.

33. The method according to claim 24 wherein causing the increase in pressure difference comprises accelerating or decelerating the cell.

34. The method according to claim 24 wherein causing the increase in pressure difference comprises applying pressure externally to the cell.

35. The method according to claim 24 wherein causing the increase in pressure difference comprises vibrating, shaking or impacting the cell.

36. A method of activating a micro-cell comprising:
applying an external stimulus to the micro-cell to at least partially collapse a barrier wherein the collapse of the barrier allows a fluid in a first compartment of the cell to pass into a second compartment of the cell.

37. The method according to claim 36 wherein application of the external stimulus breaks a sub-structure supporting the barrier such that the barrier collapses and allows the fluid to enter the second compartment.

38. The method according to claim 36 wherein the micro-cell generates an activation signal when the fluid interacts with an element in the second compartment.

39. The method according to claim 38 wherein the fluid is an electrolyte solution and the element is an electrode.

40. The method according to claim 38 wherein the activation signal comprises an electrical signal.

41. The method according to claim 38 wherein the activation signal comprises a magnetic signal.

42. The method according to claim 38 wherein the activation signal comprises a visible signal.

43. The method according to claim 38 wherein the activation signal comprises an auditory signal.

44. The method according to claim 38 wherein the activation signal comprises a thermal signal.

45. The method according to claim 36 wherein the external stimulus comprises accelerating or decelerating the micro-cell.

46. The method according to claim 36 wherein the external stimulus comprises applying pressure to the micro-cell.

47. The method according to claim 36 wherein the external stimulus comprises shaking, vibrating or impacting the micro-cell.

48. A method of activating a micro-cell comprising:
applying a voltage across a fluid and a porous barrier, wherein application of the voltage causes the fluid to flow from a first compartment, through micro-pores in the barrier, to a second compartment and wherein an activation signal is generated when the fluid interacts with an element in the second compartment.

49. The method according to claim 48 wherein the fluid is an electrolyte solution and the element is an electrode.

50. The method according to claim 48 wherein the activation signal comprises an electrical signal.

51. The method according to claim 48 wherein the activation signal comprises a magnetic signal.

52. The method according to claim 48 wherein the activation signal comprises a visible signal.

53. The method according to claim 48 wherein the activation signal comprises an auditory signal.

54. The method according to claim 48 wherein the activation signal comprises a thermal signal.

55. A method of detecting an event or stimulus applied to a micro-cell comprising:
detecting a signal representing the event or stimulus, wherein the event or stimulus causes a fluid in a first compartment of the micro-cell to pass through a porous barrier and into a second compartment of the micro-cell and wherein, upon entering the second compartment, the fluid interacts with an element in the second compartment to generate the signal.

56. The method according to claim 55 wherein, prior to applying the event or stimulus, the fluid in the first compartment of the micro-cell is isolated from the second compartment of the micro-cell by the porous barrier.

57. A method according to claim 55 wherein the event or stimulus comprises acceleration or deceleration of the micro-cell.

58. A method according to claim 55 wherein the event or stimulus comprises shaking, vibrating or impacting the micro-cell.

59. A method according to claim 55 wherein the event or stimulus comprises applying pressure to the micro-cell.

60. A method according to claim 55 wherein the event or stimulus comprises applying a voltage to the fluid in the first compartment and wherein, upon application of the voltage, the fluid passes through pores in the barrier.

61. The method according to claim 55 wherein the event or stimulus causes the porous barrier to collapse such that the fluid passes from the first compartment to the second compartment.

62. The method according to claim 55 wherein the signal representing detection of the event or stimulus comprises a color change in the fluid.

63. The method according to claim 55 wherein the signal representing detection of the event or stimulus comprises an electrical signal.

64. A method of activating a device comprising:
applying an event or stimulus to a micro-cell coupled to the device,
wherein the event or stimulus causes a fluid in a first compartment of the micro-cell to pass through a porous barrier and into a second compartment of the micro-cell, wherein an activation signal is generated when the fluid interacts with an element in the second compartment, and wherein the activation signal activates the device.

65. A method according to claim 64 wherein, prior to applying the event or stimulus, the fluid in the first compartment of the micro-cell is isolated from the second compartment of the micro-cell by the porous barrier.

66. A method according to claim 64 wherein the event or stimulus comprises acceleration or deceleration of the micro-cell.

67. A method according to claim 64 wherein the event or stimulus comprises shaking, vibrating or impacting the micro-cell.

68. A method according to claim 64 wherein the event or stimulus comprises applying pressure to the micro-cell.

69. A method according to claim 64 wherein the event or stimulus comprises applying a voltage to the fluid in the first compartment and wherein, upon application of the voltage, the fluid passes through pores in the barrier.

70. The method according to claim 64 wherein the event or stimulus causes the porous barrier to collapse such that the fluid passes from the first compartment to the second compartment.

71. The method according to claim 64 wherein the activation signal comprises an electrical signal.
